(19) United States
(12) Patent Application Publication
(10) Pub. No.: US 2015/0187194 A1
(43) Pub. Date: Jul. 2, 2015

(54) DEVICE, SYSTEM, AND METHOD OF SMOKE AND HAZARD DETECTION

(71) Applicants: Keanu Hypolite, Brooklyn, NY (US); Justin Wolf, Baldwin, NY (US); Avraham Brun-Kestler, West Hempstead, NY (US); Mechael Brun-Kestler, West Hempstead, NY (US)

(72) Inventors: Keanu Hypolite, Brooklyn, NY (US); Justin Wolf, Baldwin, NY (US); Avraham Brun-Kestler, West Hempstead, NY (US); Mechael Brun-Kestler, West Hempstead, NY (US)

(21) Appl. No.: 14/583,710

(22) Filed: Dec. 28, 2014

Related U.S. Application Data
(60) Provisional application No. 61/921,470, filed on Dec. 29, 2013.

(51) Int. Cl. G08B 17/10

(52) U.S. Cl. CPC G08B 17/10

(57) ABSTRACT

A hazard detector device comprises: a smoke detector to detect smoke, and to generate an output indicating that smoke is detected; a wireless receiver to receive, from a remote hazard detector apparatus, an incoming wireless communication signal indicating that the remote hazard detector apparatus detected a hazard; an audible alert generator to generate an audible alert in response to said incoming wireless communication signal; a wireless transmitter to transmit, to a remote alarm device, an outgoing wireless communication signal indicating that at least one of the following conditions exist: (a) the smoke detector of said hazard detector device detected smoke; (b) said hazard detector device received said incoming wireless communication signal indicating the remote hazard detector apparatus detected a hazard.

### CROSS-REFERENCE TO RELATED APPLICATIONS

The present application claims benefit and priority from U.S. provisional patent application No. 61/921,470, titled “Device, System, and Method of Smoke and Hazard Detection”, filed on Dec. 29, 2013, which is hereby incorporated by reference in its entirety.

### FIELD OF THE INVENTION

The present invention relates to the field of smoke detectors.

### BACKGROUND

Millions of households are equipped with a smoke detector or smoke alarm, able to detect smoke (typically as an indicator of fire) and to generate an audible alarm to alert the occupants of the possibility of fire. Some smoke detectors utilize optical or photoelectric detection; whereas other smoke detectors utilize a physical process or ionization.

Many households are equipped with a carbon monoxide (CO) detector. CO gas is a poisonous, colorless, tasteless and odorless compound which is virtually undetectable by humans without using a specific CO detector.

### SUMMARY

The present invention may include, for example, devices, systems, and methods for detection of smoke, fire, carbon monoxide (CO), carbon dioxide (CO2), and/or other hazards. For example, a first detector located in a first room may sense the hazard, may sound an audible alarm, and may transmit a wireless signal indicating that the hazard is detected. Other detectors, located in other rooms or floors in the same household, may receive the wireless signal and may sound an audible alarm. Additionally or alternatively, a vibrating module may be attached to a bed, may similarly receive the wireless signal, and in response, may vibrate in order to wake-up a person sleeping on that bed.

Optionally, a detector or vibration module, which receives an incoming wireless signal that was transmitted by another detector, may re-transmit or repeat the wireless signal in order to reach other units in the same household. Optionally, devices in the same household may be synced or paired or grouped by utilizing a unique identification signal, to avoid triggering of units in neighboring households. In some embodiments, optionally, if the system is pre-configured in such manner, and/or if the system determines that the hazard (e.g., fire, smoke) may adversely affect or damage nearby house(s) or apartment(s) or surroundings, then the system may further alert or send an alert notification to neighboring houses or residences and/or other third-parties (e.g., fire station, police, first responders, dispatching service, security service.)

The present invention may provide other and/or additional benefits or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative implementations of the present invention; and

FIG. 2 is a schematic block diagram illustration of another system, in accordance with some demonstrative implementations of the present invention.

### DETAILED DESCRIPTION OF THE PRESENT INVENTION

In the following detailed description, numerous specific details are set forth in order to provide a thorough understanding of some embodiments. However, it may be understood by persons of ordinary skill in the art that some embodiments may be practiced without these specific details. In other instances, well-known methods, procedures, components, units and/or circuits have not been described in detail so as not to obscure the discussion.

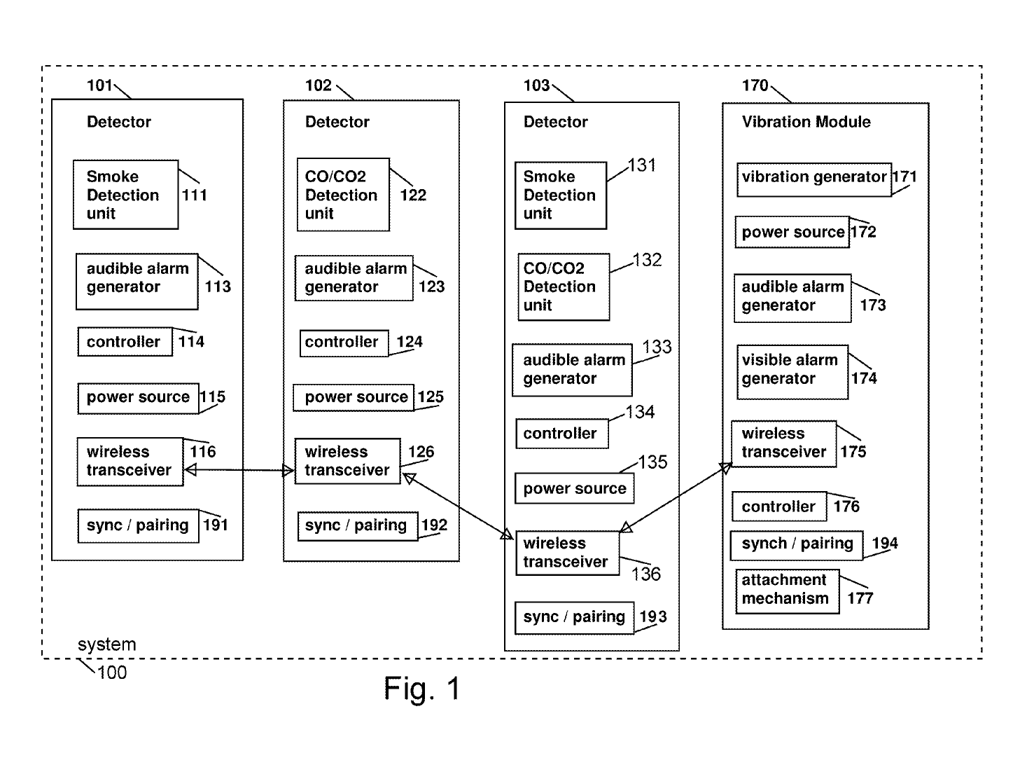

Reference is made to FIG. 1, which is a schematic block-diagram illustration of a system 100 in accordance with the present invention. System 100 may comprise, for example, detectors 101-103 and one or more vibration module(s) 170.

Detector 101 may comprise a smoke detection unit 111, an audible alarm generator 113, a controller 114, a power source 115, a wireless transceiver 116, and a synchronization/pairing module 191. Detector 101 may be located, for example, in a living room of a household.

Detector 102 may comprise a carbon monoxide (CO) and/or carbon dioxide (CO2) detection unit 122, an audible alarm generator 123, a controller 124, a power source 124, a wireless transceiver 125, and a synchronization/pairing module 192. Detector 102 may be located, for example, in a child room of the same household.

Detector 103 may be a dual-detector or a multi-hazard detector, and may comprise a smoke detection unit 131, a carbon monoxide (CO) and/or carbon dioxide (CO2) detection unit 132, an audible alarm generator 133, a controller 134, a power source 135, a wireless transceiver 136, and a synchronization/pairing module 193. Detector 103 may be located, for example, in a master bedroom of the household.

For demonstrative purposes, particular types of sensors or detectors are discussed herein as demonstrative examples; however, in accordance with the present invention, other suitable sensors and/or detectors may be utilized, in addition to or instead of such discussed sensors or detectors, in a common or unified housing or case or box, or in separate housings or cases or boxes; such auxiliary or other detectors or sensors may detect and/or sense and/or measure, for example, humidity, temperature, and/or other parameters, or may comprise a pyroelectric sensor or other suitable sensors or detectors.

In some embodiments, devices and/or units may communicate among themselves using wireless communication signals or links or networks. In other embodiments, devices and/or units may communicate among themselves using wired communication links or wired networks. In some embodiments, devices and/or units may communicate among themselves using a combination of both wired and wireless communication links or networks. In some embodiments, devices and/or units may receive power from an internal battery or power cell; and/or from an electric power outlet; and/or may be plugged-in or hard-wired to or attached to a power outlet or a power source.

Vibration module 170 may comprise, for example, a vibration generator 171, a power source 172, an audible alarm generator 173, a visible alarm generator 174 (e.g., able to generate blinking light), a wireless transceiver 175, a controller 176, and a synchronization/pairing module 194. Vibration module 170 may optionally comprise an attachment mechanism 177 (e.g., a clip or a belt) which may be utilized to attach vibration module 110 to a furniture article (e.g., a bed, a sofa, a couch). Alternatively, vibration module 170 may be placed at a suitable location within, or under, or on top of, such furniture article; for example, between a mattress and a platform of a bed.

In detector 101, smoke detection unit 111 may detect smoke. In response, controller 114 may command audible alarm generator 113 to sound an audible alarm, and audible alarm generator 113 may sound an audible alarm. Additionally, controller 114 may command wireless transceiver 116 to transmit a pre-defined wireless communication signal indicating that detector 101 has detected a hazard; and wireless transceiver 116 may transmit such wireless signal, on a one-time basis, or repeatedly, or for a pre-defined time period (e.g., one minute), and/or at pre-defined time intervals (e.g., every five seconds).

The wireless communication signal transmitted by detector 101 may be wirelessly received by wireless transceiver 125 of detector 102. In response, controller 124 of detector 102 may command audible alarm generator 123 to sound an audible alarm, and audible alarm generator 123 may sound an audible alarm; even though CO/CO2 detection unit 122 of detector 102 may not detect any CO or CO2.

Similarly, the wireless communication signal transmitted by detector 101 may be wirelessly received by wireless transceiver 135 of detector 103. In response, controller 134 of detector 103 may command audible alarm generator 133 to sound an audible alarm, and audible alarm generator 133 may sound an audible alarm; even though detector 103 may not detect any smoke or CO/CO2 in the room where detector 103 is located.

Similarly, the wireless communication signal transmitted by detector 101 may be wirelessly received by wireless transceiver 175 of vibration module 170. In response, controller 176 of vibration module 170 may command audible alarm generator 173 to sound an audible alarm, and audible alarm generator 173 may sound an audible alarm; even though the room in which vibration module 170 is located may not have smoke or CO/CO2. Additionally, controller 176 of vibration module 170 may command visible alarm generator 174 to sound an audible alarm, and visible alarm generator 174 may generate a visual alarm (e.g., a blinking red light); even though the room in which vibration module 170 is located may not have smoke or CO/CO2. Additionally, controller 176 of vibration module 170 may command vibration generator 171 to vibrate or shake, and vibration generator 171 may vibrate or shake, thereby causing vibration or shaking of a furniture (e.g., bed or sofa) to which vibration module 170 may be attached, and even though the room in which vibration module 170 is located may not have smoke or CO/CO2.

In another implementation, in detector 102, the CO/CO2 detection unit 122 may detect CO/CO2. In response, controller 124 may command audible alarm generator 123 to sound an audible alarm, and audible alarm generator 123 may sound an audible alarm. Additionally, controller 124 may command wireless transceiver 126 to transmit a pre-defined wireless communication signal indicating that detector 102 has detected a hazard; and wireless transceiver 126 may transmit such wireless signal, on a one-time basis, or repeatedly, or for a pre-defined time period (e.g., one minute), and/or at pre-defined time intervals (e.g., every five seconds). The wireless communication signal transmitted by detector 102, may be received by detector 101 which may sound an alarm in another room; and/or may be received by detector 103 which may be sound an alarm in yet another room; and/or may be received by vibration module 170 which may vibrate.

In another implementation, the combined or multi-sensor detector 103 may detect smoke and/or CO/CO2. In response, controller 134 may command audible alarm generator 133 to sound an audible alarm, and audible alarm generator 133 may sound an audible alarm. Additionally, controller 134 may command wireless transceiver 136 to transmit a pre-defined wireless communication signal indicating that detector 103 has detected a hazard; and wireless transceiver 136 may transmit such wireless signal, on a one-time basis, or repeatedly, or for a pre-defined time period (e.g., one minute), and/or at pre-defined time intervals (e.g., every five seconds). The wireless communication signal transmitted by detector 103, may be received by detector 101 which may sound an alarm in another room; and/or may be received by detector 102 which may be sound an alarm in yet another room; and/or may be received by vibration module 170 which may vibrate.

In some embodiments, any wireless transceiver (116, 126, 136, and/or 175) that receives a wireless signal, may immediately also re-transmit or amplify or repeat the wireless signal, in order to further carry the wireless signal towards other rooms or sections of the household.

The synchronization/pairing modules 191-194 may be used to synchronize or pair between pairs of devices among detectors 101-103 and/or vibration module 170. For example, each synchronization/pairing module 191-194 may comprise a button that, when pressed, transmits a unique identification signal; thereby allowing, and ensuring, that devices in the same household may be paired or synched with each other, and avoiding a situation in which a detector in a first household triggers activation of an alarm located in a second household (e.g., if the system is configured to avoid triggering of alarms external to the first household; since in some implementations, it may be desired, and the system may be configured, to trigger or activate an alarm or alert in neighboring residences upon detection of certain hazard conditions in one residence).

In accordance with some implementations of the present invention, detectors 101-103 may not require a nine-volt battery, and may not require other single-user or non-rechargeable or Alkaline battery; and rather, may comprise a rechargeable battery that may be conveniently charged using a USB port or using a wall outlet.

In some implementations, components of system 100 may communicate via a secure wireless network, such that attackers or hackers may not purposely set-off the alarm and/or disable or deactivate the system or any of its components, or otherwise misuse the system or cause an unauthorized intervention with the system.

Vibration module 170 may be attached to beds, couches, and other places where people might fall asleep, so as to wake-up heavy sleepers, elderly people, children, intoxicated people, deaf people, hearing-impaired people, or other users, regardless of where they sleep (e.g., in another room or section of the household).

In a demonstrative user case, a user may install detector 103 and vibration module 170, which may be able to communicate wirelessly through a network scheme that allows expansion and addition of further detectors and/or vibration modules. Once the two devices are synched or paired, the vibration module 170 may be attached to any desired spot, and detector 103 may be placed on the ceiling or in a high place. Detector 103 then waits for an alarming condition; and when it senses that a condition has occurred, detector 103 generates an audible alarm, and further transmits a wireless signal to multiple other detectors in the house and also to the vibration module(s) in the house, which may then vibrate at the desired spot(s), thereby causing the user(s) or tenants to wake-up.

The wireless communication of system 100 may have sufficient coverage for the average household size; and devices may not run into a problem of being out of synch with each other. For example, each device may act as a port or repeater or amplifier, and may re-send the wireless signal to cover more area. When one detector senses an alarming condition, it may send a wireless signal to the vibration module(s) and the other (or nearest) detector(s) in the house, which may then re-send the wireless signal to the other vibration module(s) and/or detectors. This allows for a mesh network system in which the devices are able to communicate with each other, thereby allowing for increased area coverage. Optionally, overlapping between the wireless signals may be used, such that if one detector becomes non-operative (e.g., due to an ongoing fire in one room), the other detectors may pick up the signal and keep the wireless notification system running. The system may thus bring not only the audible functionality of detectors, but also the vibration aspect to increase the possibility of people waking up when there is an alarming situation or a hazard.

In some implementations, each detector may utilize a photoelectric smoke detector that is connected to a wireless vibration module acting as a “bed shaker” or a “smoke vibrator”. The smoke detector may be wirelessly synched to the smoke vibrator via a single button synch system; for example, there may be a single button on each smoke detector and smoke vibrator.

The single button on the smoke detector may have multiple functionalities, for example, three (or more) functionalities. When the button is held down for a pre-defined time period (e.g., for five seconds, or for three seconds) it may cause a testing of one or more components or modules or functions of the device, for example, testing the battery life, testing the audible alarm, testing LED or other illumination units or flashing units, testing vibration module(s), testing general functionality of the device, check wireless communication signal (e.g., signal existence, signal strength, network connection, network integrity), and/or other functions or modules. A single push of the button may hush the alarm when sensing smoke in the area. When held down for ten seconds with the smoke vibrator button held down for ten seconds also, the two devices may be synced or paired. The smoke detector may have interconnection with multiple smoke detectors and smoke vibrators. On completion of synchronization between the smoke detector and the smoke vibrator, the smoke detector may flash a blue LED light (and/or may generate other signal(s), such as audible signal and/or vibration) indicating that synchronization between the smoke detector and smoke vibrator was successful.

Once the smoke detector and smoke vibrator are synced, the smoke vibrator may be placed underneath the bed (recommended) or any desired spot that the user would like it to be placed. The smoke vibrator can be placed under beds, couches, and other places where people might potentially fall asleep. The smoke vibrator may be attached to the furniture by eight small pins; for example, four pins may be on each end of the smoke vibrator, allowing it to grip on the furniture. Other suitable connection mechanisms or attachment mechanisms may be used, or other suitable attachment/detachment mechanisms, in order to secure the device to furniture or other objects without damaging them. The smoke vibrator may have a vibration motor with a harmonic resonance and pulsating vibration. Having an increasing and pulsating frequency may cause enough vibration to shake any type of bed or furniture.

In the household, the smoke detector may be synced with one or more smoke vibrators. After the smoke detector is synced, it may be placed on the ceilings of each room in the house using a base that attaches the smoke detector to the ceiling. Rooms A, B, and C may have smoke detectors and smoke vibrators in each room. The smoke detectors may automatically interconnect with each other wirelessly using a mesh network system. Using the mesh network, each household may have its main smoke detector that may connect each smoke detector. This system is implemented to prevent other smoke detectors that are in other households to connect to another household system (e.g., unless such function is pre-configured or desired or required by the user).

If an alarming condition is signaled in room A it may then send a signal out to all smoke detectors and smoke vibrators using the mesh network, alerting those that are in the household. The mesh network is used for wireless interconnection, which may eliminate the difficult process of interconnection through wires. The mesh network that the system is using works by sending a wireless signal to each smoke detector from the smoke detector that is in proximity to each other. For example, if room A signals an alarming condition, it may then cause room B smoke detector to alert and send signals to room C, which may cause room C smoke detector to alert. The mesh network is a system where each smoke detector signals to (at least) one additional or closest detector r unit, in order to increase the range of signals and/or in order to propagate the information that a hazard was detected and/or in order to trigger other units to generate an alarm.

If room A smoke detector signals an alarming condition, but room B does not get the signal from room A smoke detector, then room A smoke detector may look for the closest alternative to alert those in the household that there is an alarming condition, so room C may be the closest smoke detector that may receive the signal from room A that there is an alarming condition.

In an alarming condition, the smoke vibrator may cause the beds to shake wirelessly in room A, B, and C once they are signaled by the smoke detectors. The system may thus provide wireless interconnection amongst the smoke detector(s) and smoke vibrator(s), such that users would not have to worry about not hearing, or sleeping through an alarming condition because the smoke vibrator may then alert them by vibrating the bed or furniture.

When there is an alarming condition the smoke detector may signal an alarming tone, for example, 3100 Hz with a T3 pattern. The smoke detector may have a backup battery and also a rechargeable battery that can be plugged into a standard USB port or wall outlet. During an alarming condition, the smoke detector may flash red LED lights. When the smoke detector is tested for the battery life it may flash a green LED light signifying that the battery is charged. When the smoke detector battery is low it may then flash a yellow LED light. The smoke detector and smoke vibrator may have a secure network, so hackers cannot purposely set off the system or disable the system or otherwise interfere in unauthorized manner with the system's functionalities. It is clarified that although portions of the discussion herein may relate, for demonstrative purposes, to a green LED or to a blue LED or to other specific colors, such discussion is only non-limited examples, and the present invention may utilize various other color(s) and/or LED color(s) and/or other types of illumination units or flashing units which may have various other colors and/or patterns and/or combination of colors (e.g., yellow, amber, red, or the like).

The smoke vibrator may be a flat, thin, product with a battery that may not require charging for a long period of time (e.g., for two or more years). For example, the smoke vibrator may comprise one or more vibration modules or vibration motors, and may further comprise a controller or micro-processor able to activate and deactivate those vibration motors. Optionally, a wireless transceiver may be comprised in the smoke vibrator, in order to receive an incoming wireless communication signal indicating that a hazard (e.g., smoke) was detected and thus triggering vibration; and/or in order to transmit or repeat or propagate such wireless communication signal towards other devices on the network in order to trigger them too into activation. Optionally, a “sleep mode” or “standby mode” or “power saving” mode may be utilized, controlled by the controller or micro-processor of the smoke vibrator, in order to preserve and prolong battery life. The purpose of the smoke vibrator may be, for example, to introduce an added device to increase the safety and the chance of people waking up during alarming conditions.

In some embodiments, the smoke vibrator may not need a transmitter in order to receive an alarming condition; but may optionally comprise a transmitter in order to re-transmit the hazard signal that was received from a detector. The smoke vibrator may not require a power outlet, a transmitter, or a microphone to work, and may not operate based on audio detection of an alarm beeping in another room or in the same room. The smoke vibrator communicates through the interconnection system that intertwines the smoke vibrator and smoke detector.

When the smoke vibrator is placed on any desired furniture, it may utilize its own wireless signal that may trigger the vibration system when there is an alarming condition. The present invention may simplify the process of having a vibration tactile system by attaching the smoke vibrator to any piece of furniture that people potentially may sleep on or rest on (e.g., bed, sofa, couch). The smoke detector and smoke vibrator aim to increase the safety of those that are intoxicated, elderly, heavy sleepers, children, loss of hearing, deaf people, hearing-impaired persons, or the like.

In some implementations, the smoke and/or CO/CO2 detector may have some or all of the following features or functionalities: implemented as a six-inch diameter disk-shaped item, or as a oblong shape, or as a rectangular cuboid (e.g., five inches high, four inches wide); having full enclosure with touch screen single button or physical single button functionality; having a low power microprocessor or controller; having a periodic self-check at pre-defined time intervals; able to utilize low power sleep when it is not checking for local/remote alarms; an audible horn generator (3100 Hz); high intensity flash (CREE LED 2 watts) and/or red green and blue (RGB) LED lens; simple button silence for all alarms; optional humidity sensor, temperature sensor, and/or other environmental sensory modules or detectors or measuring units; ability to activate other devices in an alarming condition via a wireless communication signal.

In some embodiments of the present invention, a detector unit may optionally comprise a microphone or other audio-capturing unit, and optionally one or more amplifiers or amplification circuits or filters or noise-reducing circuits, able to capture audio. The captured audio may be analyzed by a micro-processor or controller or Digital Signals Processor (DSP), in order to recognize one or more audio pattern(s). Accordingly, the detector device may thus “listen” to ambient audio, and may autonomously and independently recognize smoke alarm (or hazard alarm) audible tone(s), thereby deducing autonomously (e.g., without receiving an incoming wireless communication signal) that a hazard was detected and/or that one or more other detector units are sounding an audible alarm. In some implementations, a detector unit may detect or may determine, based on capturing audio and analyzing the captured audio to identify or recognize alarm tones, that another unit has already detected or sensed a hazard (e.g., smoke or CO) and is currently generating a distinct audible alarm; thereby triggering such “listening” detector unit to activate its own alarm mechanisms (e.g., vibration, audible horn or audible alarm, flashing, illumination). This unique feature of the present invention may further allow a detector device to be added to an existing system (e.g., an existing home alarm system or smoke detection system) without necessarily having to replace all or some of existing units; and while allowing the detector units of the present invention to advantageously listen to audible alarms of conventional detectors in order to trigger alarm.

The detector may have a local/remote mode; such that the smoke detector may indicate location of smoke or hazard (e.g., local hazard in this room, or remote hazard in another room) to help users determine evacuation route.

The detector may have adjustable hush limits (e.g., a nine-minute timer); a rechargeable lithium ion battery; a battery module with integrated charge circuitry; protection circuitry (e.g., Under/Over voltage, short-circuit, over-current); a universal USB style connector for charging; may not require any 9-volt batteries; may be part of a mesh wireless network for increased distances; may utilize a simple setup/configuration process for synchronization or pairing or grouping of same-household devices; may not require a separate or stand-alone Wi-Fi router or Access Point or Hot-Spot, and may not require peer to peer networking or wired links.

In some embodiments, detector(s) may utilize secure or encrypted communications (e.g., RSA 128-bit key encryption); may have over-the-air Firmware/Settings update; a photoelectric sensor, or an optical beam sensor, or an ionization sensor; may utilize a single button functionality; and may utilize low-power circuitry.

In some implementations, a smoke vibrator (or vibration module) may comprise wireless transceiver, able to receive a wireless communication signal indicating a hazard and triggering vibration; and able to re-transmit or re-send or amplify or repeat the incoming wireless communication signals such that other devices (e.g., detectors and/or vibrator modules) may receive it. In other implementations, the smoke vibrator (or vibration module) may comprise only a wireless receiver and not necessarily a wireless transmitter, in order to receive the incoming wireless signal and to act (vibrate) upon such incoming signal, but without necessarily re-transmitting such wireless signal towards other device(s) (e.g., in order to preserve battery power and/or prolong battery life and/or reduce cost, or in order to reduce the form-factor of the vibration module).

In some implementations, a smoke vibrator (or vibration module) may support user-defined or adjustable vibration modes; may utilize harmonic resonance and/or frequency sweep.

In some implementations, a smoke vibrator (or vibration module) may be a stand-alone unit. In other implementations, a smoke vibrator (or vibration module) may be integrated with a smoke/fire/CO/CO2/detector, such that the detector and the vibration module may be integrated as a unified component within a single housing or box or enclosure (e.g., optionally sharing a power source, optionally sharing a wireless transceiver).

The invention may be implemented using suitable hardware components and/or software modules, which may include, for example, a processor, a Central Processing Unit (CPU), a Digital Signal Processor (DSP), a controller, an Integrated Circuit (IC), a memory unit, a storage unit, accumulators, buffers, a power source, wired communication links, wireless communication links, antennas, transceivers, transmitters, receivers, input units (e.g., keyboard, mouse, touchpad, touch-screen, microphone), output units (e.g., audio speakers, display, screen), or the like. One or more of the devices described herein may include an Operating System, drivers, software applications, or the like.

In some embodiments of the present invention, any device on the network that has a sensor to detect smoke or other dangerous conditions requiring the user's attention, is considered a “Sensor Device”. Sensor devices send alarm signals to all networked devices. Sensor devices may also include visual, audible or vibrational alarm mechanisms.

In some embodiments of the present invention, any device on the network that does not comprise a sensor, and that has the ability to enable a visual, audible or vibrational alarm to physically alert the user to an alarming condition, may be considered an “Alert Device”. Alert devices do not contain any sensors; and in some implementations, may not transmit an alarm signal (with the exception of enabling a test-mode).

In some embodiments of the present invention, for creating a new network: when any device is first powered on, it may automatically search for an available wireless network allowing new devices to connect thereto. If no wireless network is found, then the device may automatically create or establish a new wireless network. If a wireless network is found, but is not allowing new devices to connect thereto, then the device may alert the user to enable new devices on the network (e.g., by audible and/or visual indication) and may wait for permission from the wireless network to join it. If the wireless network is allowing new devices, then the new device may automatically join the wireless network. The new device is now connected and configured.

In some embodiments of the present invention, for adding devices to an existing network: In order to enable new devices to join the wireless network, the button command for syncing is pressed on any device already on the wireless network. This creates a secure wireless network where new devices can only be added when there is physical access to a device that is already on the wireless network. Even if a new device is within range of the network, syncing must be physically enabled (performed, actuated) from any device that is on the network, thereby preventing unauthorized access to the wireless network (e.g., by a hacker, by a neighbor).

Operation during Alarm: When any sensor device detects smoke above a set level, it may enter a local alarm mode, where it is the only device alarming. It may also alert other sensor devices to go into increased detection mode. After a short pre-defined timeout (e.g., 10 or 15 or 30 or 60 seconds), and if the alarm is not silenced (or “hushed” into a reduced-sensitivity mode) by the local (or remote) device, all alarming devices on the wireless network may activate and enter a remote alarm mode. The devices may stay in this alarm mode until either the original alarming condition clears, or until pushing the button on any networked device enabling a reduced sensitivity mode. If the reduced sensitivity mode is enabled, all sensors alarm set points are increased temporarily. If the sensors detect smoke above this increased set point, the alarm may be re-enabled and may not be able to be silenced until the smoke levels (or hazard levels) drop below the increased set point.

Operation during Test: When the user enables the test mode on any device, each sensor device enters an increased sensitivity mode, which immediately puts the device into an alarming condition. This temporarily puts the sensor device into local alarm. The user may then verify the operation of the alarm. This may be automatically done for each sensor on the network, one at a time. Additionally, all non-sensor devices are forced into remote alarm mode to ensure operation.

Some embodiments may utilize MiWi 802.15.4 (at 2.4 GHz) Personal Area Network. For example, every sensor and alert device may comprise an integrated MiWi 802.15.4 (2.4 GHz) transceiver. Using the MiWi Pro protocol, the network may be setup with a mesh type connection system, where each device is able to pass data on to any another device in range. The system automatically sends data through the most efficient path to get to the intended target. The system automatically re-routes data through alternate routes if the any device on the intended route is not responding. Other suitable wireless communication networks may be used; for example, Wi-Fi, 802.11, Wi-Max, 802.16, ZigBee, BlueTooth, peer-to-peer architecture, distributed architecture, point-to-point architecture, client/server architecture, a combination of two or more network types or networks, or the like.

Network Setup: In accordance with the present invention, setting-up a smoke or hazard detection system may be rapid and easy, may not require an existing Wi-Fi network, and/or may be performed without requiring a smartphone or tablet or laptop computer or other computing device. For example, each device may be pre-programmed to connect to any available MiWi network using a private or proprietary protocol. There are no settings to configure or other required hardware in order for the user to start using the system.

Encrypted Network: In some implementations, all or most or some data transferred on the wireless network is encrypted with a private key that may be read by any device on that network. The encryption is not necessarily meant to prevent reading of the signals, but rather to verify that the data was sent from a verified device. Only devices that have the private key may can encrypt data, and if the data is decrypted successfully, it means that the transmission was from a device with the private key.

Single Button Operation: In some implementation, setup and operation of the module may be controlled by one single button. Most or all configuration operations are done automatically and without the need for user intervention, thereby simplifying the setup of the devices. Additionally, one device may send requests to all other devices on the network, allowing operations such as synchronizing devices, silencing of the alarms, or testing of all devices to be done by one device. Although portions of the discussion herein may relate to a single-button implementation, the present invention may comprise other embodiments in which multiple buttons may be used, or other type(s) of interface components may be used in order to provide input to the device, to test the device, to program the device, to activate or deactivate the device, to link the device to a network, to perform “factory reset”, and/or to perform other suitable operations.

Synchronized Audible Alarms: In some implementations, when multiple independent alarms are located in the same general area or vicinity, the combined audible alarms can sound confusing and no longer sound like the required signal (e.g., as defined by UL standards, or other suitable standards or code or regulations). By keeping all devices synchronized, multiple alarms may still sound like the standard smoke alarm signal, or in accordance with such standards or requirements.

Rechargeable Battery and Increased Battery Life: conventional products use 9V non-rechargeable lithium batteries, or other alkaline batteries. Using low power microprocessor and efficient electronic components, long battery life may be achieved with rechargeable lithium-ion batteries or with other suitable battery or power cell or power source (e.g., NiMH battery, Lithium Iron Phosphate or LFE or LiFePO4 battery). Integrating a battery charging circuit and a USB type plug, the battery pack may be recharged by a USB wall charger and/or via computer USB port; and/or the unit or detector may optionally be plugged-in (e.g., connected to an electric power outlet) or hard-wired. Optionally, an outlet-powered carbon monoxide (CO) detector may be configured to double as a charging station. This may allow for battery changes to be done instantly, without having to find or purchase another 9V battery.

Remote Vibration Modules: Small, powerful DC vibration motors are built in to the remote vibration module. These motors may provide, for example, around 17G of normalized amplitude (or other suitable values or ranges of normalized amplitude) and are sufficiently small to be placed under (or attached to) mattresses, cushions, pillows or any inconspicuous place in which it can alert the user when sleeping or at rest. These vibration modules may aid in alerting users in which hearing an audible alarm may not be as effective due to high frequency hearing loss (e.g., due to old age or injury), deaf users, children, disabled persons, or other types of users. Vibration modules add another level of protection against ineffective or unresponsive alerts.

Minimized Nuisance Alarms: Using sensors that measure temperature and humidity, the detector may compensate for signal changes due to environmental changes. Using a combination of these sensor inputs with a moving averaged computation, the microprocessor may actively change the sensitivity level to minimize the chance of nuisance alarms.

Applicants have realized that various factors (e.g., environmental factors) may have an effect of the photoelectric sensor measurement, causing a change in the sensed output in the detector, independent of the actual smoke level. Environmental changes that can be detected by way of a sensor (humidity, temperature, barometric pressure, or the like) may be measured and may be utilized to actively compensate for these changes.

In accordance with some demonstrative embodiments of the present invention, for example, humidity (which changes on a daily basis or on an hourly basis) may have an undesired effect on the light refracted in the sensor, thereby causing a change in the sensed smoke obscuration level of the sensor. A humidity sensor may allow the micro-controller to adjust for this environmental factor, and to maintain the correct sensitivity by providing a compensation factor that is determined using the current humidity levels (namely, based on the currently-sensed humidity levels).

In accordance with some embodiments of the present invention, slow-changing environmental factors that cannot be detected by way of a sensor (e.g., air particulate, dander, pollen, dust, or the like) may be passively negated by using a moving average compensation. The moving average calculation of the photoelectric sensor may be used to maintain a proper baseline reading for the sensor. For example, such moving average (or other suitable weighting function or averaging function or statistical function) may allow the detector to passively or autonomously readjust or modify the zero-level (baseline measurement) that is used to determine the smoke obscuration level (e.g., independently, autonomously, without the need to be manually re-configured, and/or without relying on an external source). By making the zero-level a time average of the output of the photoelectric sensor, some embodiments of the present invention may eliminate the effect of slow changes in detected obscuration level that is not due to smoke in the environment but rather due to these other seasonal or temporary environmental changes.

Some embodiments of the present invention may utilize the following equation for calculating the moving average:

$${V}_{Baseline} = \frac{1}{x} {\sum }_{t = i - x}^{x} {V}_{t}$$

In the above equation, V may indicate the sensed voltage; x may indicate the number of measurements (or iterations) to be used for moving average; i may indicate the index of the most current measurement. Other suitable equations or calculations may be used.

In some embodiments, this method may make small isolated changes in measurements (e.g., actual alarming conditions, or dust due to vacuuming) have a smaller effect as the number of iterations (denoted x) increase.

Eliminating false alarms due to temperature and humidity leaves only other environmental variables like dust or other airborne particulate. These false positives may be minimized by use of a carbon monoxide (CO) sensor. For example, CO sensor may be used in smoke detector to detect small changes in CO levels in order to verify an alarming condition. CO detectors in smoke alarms may not prevent CO poisoning, due to possible gas leakage of appliances such as gas driers or heaters. A standalone CO detector may also be provided as component of the system.

Automatic Sensor Sensitivity and Level Compensation: Applicants have realized that various factors may affect the sensitivity of smoke detectors. For example, photoelectric smoke detectors rely on an infrared LED to detect smoke particulate in the air. As battery or source voltage changes, the LED brightness may change, which in turn affects the sensor's effective smoke level reading. Additionally, when the LED voltage changes, the sensitivity of the photoelectric smoke sensor changes as well. In accordance with some embodiments of the present invention, the sensor device may use an algorithm that automatically compensates for system voltage levels and adjusts the sensitivity accordingly, to maintain a stable sensor measurement and sensitivity across a wide voltage range.

The Applicants have realized that by experimentally measuring the photoelectric sensor with different smoke obscuration levels and at different system voltages, it may be found that the sensed voltage and differential voltage above baseline (the measurement that correlates to smoke obscuration level) can be mathematically adjusted to a reference voltage reading that results in a compensated obscuration measurement that remains fairly constant over a wide voltage range.

In one implementation, for example, to derive the equation for voltage compensation, measurements were taken of input voltage (applied system voltage) and output voltage (detector sensed output voltage) for a range of smoke obscuration levels. A sensitivity adjustment was determined to maintain constant sensitivity to the maximum sensitivity as determined by the maximum system voltage (maximum sensitivity is during the highest input voltage, since sensitivity is directly proportional to light output of the sensor's LED). The measured data was graphed to demonstrate the two experimentally determined relationships between Input (system) Voltage versus Output (sensor) Voltage and Sensitivity; and both were linear relationships.

In accordance with some embodiments of the invention, the following relationship(s) may be used as part of the compensation algorithm: (a) As system voltage decreases, the baseline output (measured) voltage decreases linearly in proportion to the system voltage. (b) Sensitivity is the amount of change in voltage for a particular change in smoke obscuration; and as system voltage decreases, sensitivity decreases linearly in proportion to the system voltage (negatively). In accordance with the present invention, a microprocessor or chip or logic circuit or algorithm or controller may be implemented to utilize one or more of these relationships as a basis for compensating for obstructions.

In a demonstrative experiment, sampled data was taken with a Multimeter, and it was realized by the Applicants that relationships were generally linear. Sensitivity Adjustment is the amount of voltage needed to offset the reduction in sensitivity due to lowered system voltage.

Combining these two linear equations results in an equation that may be expressed as:

V_{Compensated}=C₁(V_{System})+C₂(V_{Max}−V_{System})

In the above equation, C₁ may indicate the compensation constant due to change in LED intensity; and C₂ may indicate the compensation constant due to change in sensitivity.

In several experiments, a graph showed actual measured data captured by the device and the resultant mathematical data used to derive the constants for the above equation. These experiments were repeated multiple times, resulting in the same linear relationship over every level of smoke obscuration level.

Expandability and Connectivity: in some implementations, the MiWi network may handle up to 1,024 connected devices. This is in contrast with some conventional systems, that may be able to support up to 18 devices per home, and/or a total of 2 homes per account.

Some implementations may provide additional or different modules to expand the system's alarm capabilities, without the need to upgrade or purchase additional support hardware. Such additional modules may comprise, for example, High-Intensity Flashers, Low-Frequency speakers, or Emergency Path Lighting or Signage, to increase the alarming capability of the system. Also, modules to add remote connectivity via Ethernet, Wi-Fi, Telephone, GSM/CDMA or Text Messaging may be used in the system. Each such module may be compatible with the main system of the present invention. Additional sensors may also be used, such as CO (Carbon Monoxide) sensor, Flammable Gas sensor, CO2 sensor, Heat Sensors, or the like. These modules may connect to the system easily and increase the system's safety and dependability.

The system may be secure, and may not be accessible or controllable by anyone other than the owner of the system. In some embodiments, remote accessibility may be limited to checking the system status only, and not to other operations.

Some implementations may utilize smartphone (or tablet) support for 802.15.4 ZigBee/MiWi 2.4 GHz technology; thus allowing direct connection from smartphone/tablet to the system's devices via a mobile application. While full functionality may be available without any additional hardware, the incorporation of smart home networks utilizing 802.15.4 ZigBee/MiWi technology, may allow other devices to communicate with the devices and system of the present invention.

Increased System Reliability: A single point of failure is a part of a system in which one single failure results in the failure of the entire system. Such failure may be prevented by using a secondary device that provides the same functionality, should the primary device fail. This increases reliability but also increases cost. Smoke detectors are not required to prevent single points of failure, and are only required to alert the user of a failure that prevents proper operation of the detector. However, some failures may not be able to be determined by the device, and/or other failures, may prevent audible or visual indication of the failure; for example: Removal of battery; Photoelectric sensor (Infrared LED) failure; Audible horn or LED indication failure; Low battery level; Wireless network failure. The present invention may be structured or configured to overcome such point(s) of failure.

Removal of Battery: When current smoke detectors have the batteries removed, there is no indicator that reminds users of this situation. Some smoke detectors blink at regular intervals to show that the detector is operating, but unless the user is actively looking at the detector, the user may not be aware of the detector's loss of power. In contrast, the system of the present invention may be able to determine when one or more detectors on the wireless network go offline (e.g., due to battery failure, or removal of battery, or battery being held incorrectly inside the housing, or battery moving or shifting internally, or accumulation of rust or moisture, or the like). Some embodiments may utilize a “small coin” battery or power cell, to provide minimal system functionality when the main battery is removed.

Photoelectric Sensor (Infrared LED) Failure: In some embodiments, the photoelectric sensor may have a measurable level during no-smoke conditions. This provides a background reading that allows a failure of the infrared LED output level to be determined. Using a microprocessor or controller, the system may measure system voltage and determine the photoelectric sensor's minimum level and warn the user when the photoelectric sensor level drops below a preset threshold.

Audible horn or LED Indication Failure: Conventional devices may not be able to determine an audible horn failure or a LED indicator failure. Moreover, in the case of secondary remote alarms that sense the audible horn to provide secondary alert functionality, this failure prevents these secondary devices from functioning. In some embodiments of the present invention, the system comprises an integrated mesh network that provides a wireless signal (e.g., non-audible signal) to all other devices in addition to the audible horn and LED indication. This wireless signal provides all secondary remote alarms a means to provide the user multiple remote alarms with audible, visual and/or vibrational indications.

Wireless Network Failure: Some conventional devices may attempt to utilize external Wi-Fi routers to communicate. Wi-Fi networks can be unstable, may go offline or may become unavailable, and are subject to power outages. When there is a failure of the Wi-Fi infrastructure, such existing devices also lose their means of communication. In contrast, the devices of the present invention may utilize a 2.4 GHz integrated network that provides a mesh network that may not require a central communication router. This prevents the failure of one device from preventing a wireless signal from reaching other devices. Each device may communicate with any device in range. As more devices are added to the network, the network becomes more reliable.

Low Battery Level: All UL certified smoke detectors should provide a minimum of 24 hours of standby and 4 minutes of alarm upon indication of a low battery. When the device can no longer maintain this level of protection, a visual or audible signal must be provided once per minute for a minimum of 7 days. This requirement is the cause of many deaths from to removal of the battery without replacement, due to a constant annoying chirp. In contrast, the present invention may lengthen the time of alert before a low battery condition meets this requirement. Alerting the user early without the annoyance of a once-per-minute chirp, gives the user a much longer time to replace the battery, and/or prevents users from prematurely removing the battery before it can be replaced.

Optionally, the device may extend the time it can provide protection in this low battery condition, by increasing the time the sensor is in standby by fractions of a second. This may not prolong the effective time to indicate an alarming condition, but rather, provides a noticeable increase in battery life. For example, if the sensor under normal conditions checks the photoelectric sensor once every 10 seconds, when a low battery is detected the delay is extended by 500 milliseconds (to be 10.5 seconds). This may be implemented, for example, by a power-saving mode or module, or by a battery-life-prolonging module, which may sense that the battery power level is low (e.g., below a pre-defined threshold value); and may re-program or configure or control one or more sensors or the detection device, to sample the environment (e.g., to perform detection operations or measurement operations) less frequently, or at increased time intervals, or at lower rate (e.g., 3 or 5 or 10 percent less frequent, relative to regular operation). A demonstrative calculation shows that this effectively increases the battery life by over 8 hours every week in this mode:

(7×24×3,600×(10.5/10))−(7×24×3,600)=30,240 seconds=8.4 hours

In some embodiments, the system may utilize or may comprise the following demonstrative components: (a) Microprocessor, for example, Advanced 8-bit Harvard architecture, clock speed of 16 MHz, program memory of 64 kilobytes, RAM memory of 3.7 kilobytes, EEPROM memory of 128 kilobytes; (b) Wireless Transceiver, for example, utilizing a protocol such as MiWi Pro Mesh Network, at frequency of 2.4 GHz, with encryption of 128 bit AES Private Keyed Encryption; (c) Photoelectric Sensor, for example, Wavelength 880 nm, with LED beam width of 10 degrees, with Phototransistor Acceptance Angle of 18 degrees; (d) Vibration Motor(s), for example four vibration motors, each one having a frequency in the range of 100 to 600 Hz, Minimum Vibration Amplitude of 5.5 G, Maximum Vibration Amplitude of 17 G, Typical Vibration Amplitude of 6.8 G, Rated Voltage of 3 volts, Rated Speedof 7300 RPM; (e) Audible Horn(s), or several such horns, each one having a Frequency of 2.4 KHz, Typical Amplitude of 85 dB, and Rated Voltage of 3 volts. Other suitable components and/or parameter values may be used.

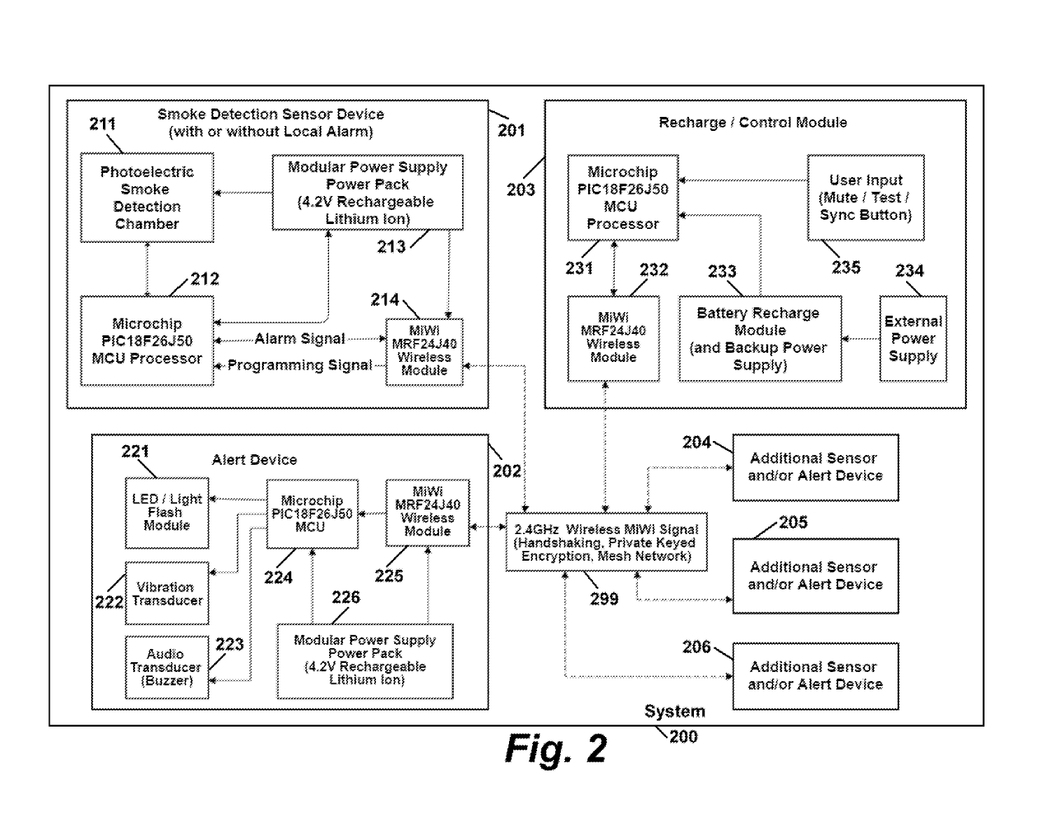

Reference is made to FIG. 2, which is a schematic block-diagram illustration of a system 200 in accordance with some demonstrative embodiments of the present invention. System 200 may be implemented by utilizing a suitable combination of hardware components and/or software modules. System 200 may comprise, for example: a smoke detection sensor device 201; an alert device 202; a recharge/control module 203; additional one or more sensor and/or alert devices 204-206. The components of system 200 may be able to communicate among themselves via a wireless communication network, or via one or more wireless communication links for example, utilizing a 2.4 Ghz wireless network 299.

Smoke detection sensor device 201 may comprise, for example: a photoelectric smoke detection chamber 211; a microchip/processor 212; a modular power supply/power pack 213; and a wireless communication module 214 (e.g., wireless transceiver).

Alert device 202 may comprise, for example: a LED/Light flash module 221 able to produce a visible alert; a vibration transducer 222 able to generate a vibration alert; an audio transducer 223 (or buzzer, or horn, or speaker, or loudspeaker) able to generate an audible alert; a microchip 224 or processor; a wireless module 225 (e.g., wireless transceiver); and a module power supply/power pack 226.

Recharge/control module 203 may comprise, for example: a microchip/processor 231; a wireless module 232 (e.g., wireless transceiver); a battery recharge module 233 (e.g., a module able to recharge, or to supply charging power to, a rechargeable battery of another component of system 200 that is positioned within or nearby); an external power supply 234 (e.g., connection to a wall power outlet); a user input module 235 (e.g., one or more buttons for mute, test, sync and/or other functions).

Optionally, system 200 may comprise other components or modules, e.g., “smart home” devices or modules, or “smart home” compatible devices or modules; as well as a smartphone, a tablet, a smart-watch device, a glasses-type or wearable computing device, or the like; and such additional devices may optionally be able to communicate with, or to control, or to receive data from, or to send instructions to, one or more of the other components of system 200.

In accordance with some embodiments of the present invention, a hazard detector device may comprise: a smoke detector to detect smoke, and to generate an output indicating that smoke is detected; a wireless receiver to receive, from a remote hazard detector apparatus, an incoming wireless communication signal indicating that the remote hazard detector apparatus detected a hazard; an audible alert generator to generate an audible alert in response to said incoming wireless communication signal; a wireless transmitter to transmit, to a remote alarm device, an outgoing wireless communication signal indicating that at least one of the following conditions exist: (a) the smoke detector of said hazard detector device detected smoke; (b) said hazard detector device received said incoming wireless communication signal indicating the remote hazard detector apparatus detected a hazard. In some embodiments, a single hazard detector device may be able to transmit (e.g., at different times) both types of the outgoing wireless communication signal, namely, an outgoing wireless signal indicating that the smoke detector detected smoke, and/or an outgoing wireless signal indicating that the device received an incoming wireless signal from a remote detection apparatus that detected smoke (or other hazard).

In some embodiments, the wireless transmitter is to propagate the incoming wireless communication signal towards one or more remote alarm units.

In some embodiments, the hazard detector device may further comprise: a vibration module to generate a vibration alert, in response to said incoming wireless communication signal indicating the remote hazard detector apparatus detected a hazard.

In some embodiments, the hazard detector device may further comprise: a vibration module to generate a vibration alert, in response to said output indicating that smoke is detected by said hazard detector device.

In some embodiments, the hazard detector device may further comprise one or more calibration units or calibration modules, able to configure or modify (e.g., dynamically; in real time) one or more of the operational parameters (e.g., threshold value, sensitivity level) of one or more sensors or detectors of the hazard detector device; based on sensing or measurements of environmental parameters; autonomously, based on locally-sensed environmental parameters; and/or based on an incoming signal (e.g., incoming wireless communication signal) that indicates such environmental parameters (e.g., sensed or measured by a remote unit or a separate device).

In some embodiments, the hazard detector device may further comprise: a humidity sensor to measure humidity level in an environment in which said hazard detector device is located; a calibration module to calibrate the smoke detector based on the measured humidity level, by modifying a baseline value utilized by said smoke detector.

In some embodiments, the hazard detector device may further comprise: a dust sensor to measure dust level in an environment in which said hazard detector device is located; a calibration module to calibrate the smoke detector based on the measured dust level, by modifying a baseline value utilized by said smoke detector.

In some embodiments, the hazard detector device may further comprise: a temperature sensor to measure temperature in an environment in which said hazard detector device is located; a calibration module to calibrate the smoke detector based on the measured temperature, by modifying a baseline value utilized by said smoke detector.

In some embodiments, the hazard detector device may further comprise: a sensor to measure one or more environmental changes in an environment in which said hazard detector device is located; a calibration module (A) to iteratively calculate a moving average of the measured environmental changes, and (B) to calibrate the smoke detector based on said moving average by modifying a baseline value utilized by said smoke detector.

In some embodiments, the hazard detector device may further comprise: a battery to provide power to one or more components of the hazard detector device; a power sensing module to detect a decrease in a voltage that is provided by said battery; a calibrator module to decrease a baseline measured voltage, that is produced by said smoke detector, linearly in proportion to the detected decrease in voltage that is provided by said battery.

In some embodiments, the hazard detector device may further comprise: a battery to provide power to one or more components of the hazard detector device; a power sensing module to detect a decrease in a voltage that is provided by said battery; a calibrator module to decrease a sensitivity threshold, that is utilized by said smoke detector, linearly in proportion to the detected decrease in voltage that is provided by said battery.

In some embodiments, the smoke detector device utilizes a LED-based photoelectric detector associated with a LED unit; and a sensor to detect a decrease in an intensity of illumination that is provided by said LED unit; and a calibrator module to decrease a sensitivity threshold, that is utilized by said smoke detector, based on the detected decrease in intensity of illumination that is provided by said LED unit.

In some embodiments, the wireless receiver is to receive an incoming wireless signal from a remote Carbon Monoxide sensor indicating a remote detection of Carbon Monoxide; wherein the audible alert generator is to generate an audible alert in response to said incoming wireless signal indicating the remote detection of Carbon Monoxide.

In some embodiments, the hazard detector device may further comprise: a button able to be activated by a user; a wireless network creation and joining module, which, in response to said button being activated by the user, is: (A) to check if a local wireless communication network dedicated to hazard detection already exists; (B) if the check result is positive, to join said local wireless communication network that is dedicated to hazard detection; (C) if the check result is negative, to create a new local wireless communication network that is dedicated to hazard detection.

In some embodiments, the hazard detector device may further comprise: a button able to be activated by a user; a wireless network creation and joining module, which, in response to said button being activated by the user, is: (A) to check if there already exists a local 802.15.4 Wireless Personal Area Network (WPAN) dedicated to hazard detection; (B) if the check result is positive, to join said local 802.15.4 Wireless Personal Area Network that is dedicated to hazard detection; (C) if the check result is negative, to create a new local 802.15.4 Wireless Personal Area Network that is dedicated to hazard detection.

In some embodiments, the wireless transmitter is to transmit said outgoing wireless communication signal to a remote vibration device that comprises a vibration generator, to command said remote vibration device to generate vibrations indicating hazard detection.

In some embodiments, the wireless transmitter is to transmit said outgoing wireless communication signal to a remote vibration device that comprises a vibration generator and that excludes a hazard sensor, to command said remote vibration device to generate vibrations indicating hazard detection.

In some embodiments, the hazard detector device may further comprise: a microphone to capture ambient audio; a processor (A) to analyze the captured ambient audio, and (B) to recognize in the captured ambient audio an audible tone indicating that a remote detection unit detected a hazard and generated an audible alarm, and (C) to trigger the audible alert generator of the hazard detector to generate an audible alarm.

In some embodiments, the wireless transmitter is to transmit said outgoing wireless communication signal to a remote illumination device that comprises a flashing illumination unit and that excludes a hazard sensor, to command said remote illumination device to generate flashing illuminations indicating hazard detection.

In some embodiments, the hazard detector device may further comprise: a pairing module to transmit and receive unique identification codes in order to pair said hazard detector device with another hazard detector device co-located within a same building.

In some embodiments, the hazard detector device may further comprise: a synchronization module to transmit and receive unique identification codes in order to synchronize said hazard detector device with a hazard detector apparatus co-located within a same building; wherein the synchronization module is to cause said hazard detector device and said hazard detector apparatus to generate synchronized audible alarms that conform to a pre-defined audible alarm.

Discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Functions, operations, components and/or features described herein with reference to one or more embodiments of the present invention, may be combined with, or may be utilized in combination with, one or more other functions, operations, components and/or features described herein with reference to one or more other embodiments of the present invention.

While certain features of the present invention have been illustrated and described herein, many modifications, substitutions, changes, and equivalents may occur to those skilled in the art. Accordingly, the claims are intended to cover all such modifications, substitutions, changes, and equivalents

What is claimed is:

1. A hazard detector device comprising:
a smoke detector to detect smoke, and to generate an output indicating that smoke is detected;
a wireless receiver to receive, from a remote hazard detector apparatus, an incoming wireless communication signal indicating that the remote hazard detector apparatus detected a hazard;
an audible alert generator to generate an audible alert in response to said incoming wireless communication signal;
a wireless transmitter to transmit, to a remote alarm device, an outgoing wireless communication signal indicating that at least one of the following conditions exist: (a) the smoke detector of said hazard detector device detected smoke; (b) said hazard detector device received said incoming wireless communication signal indicating the remote hazard detector apparatus detected a hazard.

2. The hazard detector device of claim 1, wherein the wireless transmitter is to propagate the incoming wireless communication signal towards one or more remote alarm units.

3. The hazard detector device of claim 1, further comprising:
a vibration module to generate a vibration alert, in response to said incoming wireless communication signal indicating the remote hazard detector apparatus detected a hazard.

4. The hazard detector device of claim 1, further comprising:
a vibration module to generate a vibration alert, in response to said output indicating that smoke is detected by said hazard detector device.

5. The hazard detector device of claim 1, further comprising:
a humidity sensor to measure humidity level in an environment in which said hazard detector device is located;
a calibration module to calibrate the smoke detector based on the measured humidity level, by modifying a baseline value utilized by said smoke detector.

6. The hazard detector device of claim 1, further comprising:
a dust sensor to measure dust level in an environment in which said hazard detector device is located;
a calibration module to calibrate the smoke detector based on the measured dust level, by modifying a baseline value utilized by said smoke detector.

7. The hazard detector device of claim 1, further comprising:
a temperature sensor to measure temperature in an environment in which said hazard detector device is located;
a calibration module to calibrate the smoke detector based on the measured temperature, by modifying a baseline value utilized by said smoke detector.

8. The hazard detector device of claim 1, further comprising:
a sensor to measure one or more environmental changes in an environment in which said hazard detector device is located;
a calibration module (A) to iteratively calculate a moving average of the measured environmental changes, and (B) to calibrate the smoke detector based on said moving average by modifying a baseline value utilized by said smoke detector.

9. The hazard detector device of claim 1, further comprising:
a battery to provide power to one or more components of the hazard detector device;
a power sensing module to detect a decrease in a voltage that is provided by said battery;
a calibrator module to decrease a baseline measured voltage, that is produced by said smoke detector, linearly in proportion to the detected decrease in voltage that is provided by said battery.

10. The hazard detector device of claim 1, further comprising:
a battery to provide power to one or more components of the hazard detector device;
a power sensing module to detect a decrease in a voltage that is provided by said battery;
a calibrator module to decrease a sensitivity threshold, that is utilized by said smoke detector, linearly in proportion to the detected decrease in voltage that is provided by said battery.

11. The hazard detector device of claim 1, wherein the smoke detector device comprises:
a LED-based photoelectric detector associated with a LED unit;
a sensor to detect a decrease in an intensity of illumination that is provided by said LED unit;
a calibrator module to decrease a sensitivity threshold, that is utilized by said smoke detector, based on the detected decrease in intensity of illumination that is provided by said LED unit.

12. The hazard detector device of claim 1, wherein the wireless receiver is to receive an incoming wireless signal from a remote Carbon Monoxide sensor indicating a remote detection of Carbon Monoxide;
wherein the audible alert generator is to generate an audible alert in response to said incoming wireless signal indicating the remote detection of Carbon Monoxide.

13. The hazard detector device of claim 1, further comprising:
a button able to be activated by a user;
a wireless network creation and joining module, which, in response to said button being activated by the user, is: (A) to check if a local wireless communication network dedicated to hazard detection already exists; (B) if the check result is positive, to join said local wireless communication network that is dedicated to hazard detection; (C) if the check result is negative, to create a new local wireless communication network that is dedicated to hazard detection.

14. The hazard detector device of claim 1, further comprising:
a button able to be activated by a user;
a wireless network creation and joining module, which, in response to said button being activated by the user, is: (A) to check if there already exists a local 802.15.4 Wireless Personal Area Network (WPAN) dedicated to hazard detection; (B) if the check result is positive, to join said local 802.15.4 Wireless Personal Area Network that is dedicated to hazard detection; (C) if the check result is negative, to create a new local 802.15.4 Wireless Personal Area Network that is dedicated to hazard detection.

15. The hazard detector device of claim 1, wherein the wireless transmitter is to transmit said outgoing wireless communication signal to a remote vibration device that comprises a vibration generator, to command said remote vibration device to generate vibrations indicating hazard detection.

16. The hazard detector device of claim 1, wherein the wireless transmitter is to transmit said outgoing wireless communication signal to a remote vibration device that comprises a vibration generator and that excludes a hazard sensor, to command said remote vibration device to generate vibrations indicating hazard detection.

17. The hazard detector device of claim 1, comprising:
a microphone to capture ambient audio;
a processor (A) to analyze the captured ambient audio, and (B) to recognize in the captured ambient audio an audible tone indicating that a remote detection unit detected a hazard and generated an audible alarm, and (C) to trigger the audible alert generator of the hazard detector to generate an audible alarm.

18. The hazard detector device of claim 1, wherein the wireless transmitter is to transmit said outgoing wireless communication signal to a remote illumination device that comprises a flashing illumination unit and that excludes a hazard sensor, to command said remote illumination device to generate flashing illuminations indicating hazard detection.

19. The hazard detector device of claim 1, further comprising:
a pairing module to transmit and receive unique identification codes in order to pair said hazard detector device with another hazard detector device co-located within a same building.

20. The hazard detector device of claim 1, further comprising:
a synchronization module to transmit and receive unique identification codes in order to synchronize said hazard detector device with a hazard detector apparatus co-located within a same building; wherein the synchronization module is to cause said hazard detector device and said hazard detector apparatus to generate synchronized audible alarms that conform to a pre-defined audible alarm.
